(19) United States
(12) Patent Application Publication
(10) Pub. No.: US 2021/0002404 A1
(43) Pub. Date: Jan. 7, 2021

(54) RESINS FOR USE AS TIE LAYER IN MULTILAYER STRUCTURE AND MULTILAYER STRUCTURES COMPRISING THE SAME

(71) Applicant: Dow Global Technologies LLC, Midland, MI (US)

(72) Inventors: Brian W. Walther, Lake Jackson, TX (US); Rebecca Putans, Midland, MI (US); Qichun Wan, Midland, MI (US); Yongfu Li, Midland, MI (US); Rachel E. M. Brooner, Midland, MI (US); Matthew T. Bishop, Midland, MI (US); Yong Zheng, Manvel, TX (US)

(21) Appl. No.: 16/970,497

(22) PCT Filed: Mar. 7, 2019
(86) PCT No.: PCT/US2019/021103

§ 371 Date: Aug. 17, 2020

Related U.S. Application Data
(60) Provisional application No. 62/649,644, filed on Mar. 29, 2018.

(51) Int. Cl. C08F 255/02; C08K 5/09; B32B 27/08; B32B 27/32; B32B 15/085; B32B 23/08; B32B 27/30; B32B 27/34; B32B 27/36; B32B 7/12; B65D 65/40

(52) U.S. Cl. CPC C08F 255/02; C08K 5/09; B32B 27/08; B32B 27/32; B32B 15/085; B32B 23/08; B32B 2439/00; B32B 27/34; B32B 27/36; B32B 27/365; B32B 7/12; B65D 65/40; B32B 2270/00; B32B 27/306

(57) ABSTRACT

The present invention provides resins that can be used as a tie layer in a multilayer structure and to multilayer structures comprising one or more tie layers formed from such resins. In one aspect, a resin for use as a tie layer in a multilayer structure comprises a maleic anhydride grafted polyolefin, and an inorganic Brønsted acid catalyst. In some aspects, the inorganic Brønsted acid catalyst comprises sodium bisulfate, monosodium phosphate, disodium phosphate, phosphoric acid, or combinations thereof.

### FIELD

The present invention relates to resins that can be used as a tie layer in a multilayer structure and to multilayer structures comprising one or more tie layers formed from such resins.

### INTRODUCTION

Polyethylene, polypropylene, and other polyolefins have numerous applications in food packaging, pipes, bottles, bags, and other products. However, the low surface energy and low polarity of polyolefins greatly limit their application when printing, painting, and/or adhesion are desired. Many attempts have been made to improve the adhesion and printability of polyolefins, including surface physical and chemical treatments, blending with polar polymers, using tie layers, etc. There remains a need for simple solutions to further improve the adhesion of a polyolefin with itself or with other polar/non-polar substrates such as ethylene vinyl alcohol (EVOH), polyamide (nylon), or polyethylene terephthalate (PET).

In the context of multilayer structures, the inclusion of layers of ethylene vinyl alcohol (EVOH), polyamide (nylon), and/or polyethylene terephthalate (PET) can provide oxygen barrier and water vapor barrier properties which can be advantageous for some applications such as food packaging. One way to incorporate such layers into multilayer structures that also include polyolefin layers is to provide a tie layer that will adhere the barrier layer to a polyolefin layer. However, as production rates for multilayer structures continue to increase, there may not be enough reaction time for the tie layer to bond with the barrier layer which can result in poor adhesion, lead to interlayer instability, and potential product failure. Similar issues arise when producing multilayer structures that incorporate other layers formed from polar polymers.

There remains a need for new tie layers for multilayer structures that incorporate polyolefin layers and can adhere a polyolefin layer to other layers formed from polymers such as EVOH, polyamide, polycarbonate, and others.

### SUMMARY

The present invention provides tie layer resin formulations that in some aspects provide increased adhesion in multilayer structures in a shorter period of time than conventional tie layer resins. For example, in some aspects, tie layers formed from such resins not only bind different layers together (e.g., a polyethylene layer with EVOH or polyamide), but can also do so at increased manufacturing line speeds.

In one aspect, the present invention provides a resin for use as a tie layer in a multilayer structure, the resin comprising a maleic anhydride grafted polyolefin, and an inorganic Brønsted acid catalyst. In some embodiments, the inorganic Brønsted acid catalyst comprises sodium bisulfate, monosodium phosphate, disodium phosphate, phosphoric acid, or combinations thereof.

In another aspect, the present invention provides a multilayer structure comprising at least three layers, each layer having opposing facial surfaces and arranged in the order A/B/C, wherein Layer A comprises polyolefin; Layer B comprises a blend of a second polyolefin, a maleic anhydride grafted polyolefin, and an inorganic Brønsted acid catalyst, wherein Layer B comprises 50 to 2000 ppm of the catalyst based on the total weight of Layer B, and wherein a top facial surface of Layer B is in adhering contact with a bottom facial surface of Layer A; and Layer C comprises ethylene vinyl alcohol, polyamide, polycarbonate, polyethylene terephthalate, polyethylene terephthalate glycol-modified, polyethylene furanoate, cellulose, metal substrate, or combinations thereof, wherein a top facial surface of Layer C is in adhering contact with a bottom facial surface of Layer B. In some embodiments, the inorganic Brønsted acid catalyst comprises sodium bisulfate, monosodium phosphate, disodium phosphate, phosphoric acid, or combinations thereof.

These and other embodiments are described in more detail in the Detailed Description.

### BRIEF DESCRIPTION OF THE DRAWINGS

FIG. 1 shows the results of attenuated Fourier-transform infrared spectroscopy for certain samples as described in the Examples section.

### DETAILED DESCRIPTION

Unless stated to the contrary, implicit from the context, or customary in the art, all parts and percents are based on weight, all temperatures are in ° C., and all test methods are current as of the filing date of this disclosure.

The term “composition,” as used herein, refers to a mixture of materials which comprises the composition, as well as reaction products and decomposition products formed from the materials of the composition.

“Polymer” means a polymeric compound prepared by polymerizing monomers, whether of the same or a different type. The generic term polymer thus embraces the term homopolymer (employed to refer to polymers prepared from only one type of monomer, with the understanding that trace amounts of impurities can be incorporated into the polymer structure), and the term interpolymer as defined hereinafter. Trace amounts of impurities (for example, catalyst residues) may be incorporated into and/or within the polymer. A polymer may be a single polymer, a polymer blend or a polymer mixture, including mixtures of polymers that are formed in situ during polymerization.

The term “interpolymer,” as used herein, refers to polymers prepared by the polymerization of at least two different types of monomers. The generic term interpolymer thus includes copolymers (employed to refer to polymers prepared from two different types of monomers), and polymers prepared from more than two different types of monomers.

The terms “olefin-based polymer” or “polyolefin”, as used herein, refer to a polymer that comprises, in polymerized form, a majority amount of olefin monomer, for example ethylene or propylene (based on the weight of the polymer), and optionally may comprise one or more comonomers.

The term, “ethylene/α-olefin interpolymer,” as used herein, refers to an interpolymer that comprises, in polymerized form, a majority amount (>50 mol %) of units derived from ethylene monomer, and the remaining units derived from one or more α-olefins. Typical α-olefins used in forming ethylene/α-olefin interpolymers are C₃-C₁₀ alkenes.

The term, “ethylene/α-olefin copolymer,” as used herein, refers to a copolymer that comprises, in polymerized form, a majority amount (>50 mol %) of ethylene monomer, and an α-olefin, as the only two monomer types.

The term “α-olefin”, as used herein, refers to an alkene having a double bond at the primary or alpha (a) position.

The term “in adhering contact” and like terms mean that one facial surface of one layer and one facial surface of another layer are in touching and binding contact to one another such that one layer cannot be removed from the other layer without damage to the interlayer surfaces (i.e., the in-contact facial surfaces) of both layers.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

“Polyethylene” or “ethylene-based polymer” shall mean polymers comprising a majority amount (>50 mol %) of units which have been derived from ethylene monomer. This includes polyethylene homopolymers or copolymers (meaning units derived from two or more comonomers). Common forms of polyethylene known in the art include Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE). These polyethylene materials are generally known in the art; however, the following descriptions may be helpful in understanding the differences between some of these different polyethylene resins.

The term “LDPE” may also be referred to as “high pressure ethylene polymer” or “highly branched polyethylene” and is defined to mean that the polymer is partly or entirely homo-polymerized or copolymerized in autoclave or tubular reactors at pressures above 14,500 psi (100 MPa) with the use of free-radical initiators, such as peroxides (see for example U.S. Pat. No. 4,599,392, which is hereby incorporated by reference). LDPE resins typically have a density in the range of 0.916 to 0.935 g/cm³.

The term “LLDPE”, includes both resin made using the traditional Ziegler-Natta catalyst systems and chromium-based catalyst systems as well as single-site catalysts, including, but not limited to, bis-metallocene catalysts (sometimes referred to as “m-LLDPE”) and constrained geometry catalysts, and includes linear, substantially linear or heterogeneous polyethylene copolymers or homopolymers. LLDPEs contain less long chain branching than LDPEs and includes the substantially linear ethylene polymers which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or 5,854,045). The LLDPEs can be made via gas-phase, solution-phase or slurry polymerization or any combination thereof, using any type of reactor or reactor configuration known in the art.

The term “MDPE” refers to polyethylenes having densities from 0.926 to 0.935 g/cm³. “MDPE” is typically made using chromium or Ziegler-Natta catalysts or using single-site catalysts including, but not limited to, bis-metallocene catalysts and constrained geometry catalysts, and typically have a molecular weight distribution (“MWD”) greater than 2.5.

The term “HDPE” refers to polyethylenes having densities greater than about 0.935 g/cm³ and up to about 0.970 g/cm³, which are generally prepared with Ziegler-Natta catalysts, chrome catalysts or single-site catalysts including, but not limited to, bis-metallocene catalysts and constrained geometry catalysts.

The term “ULDPE” refers to polyethylenes having densities of 0.880 to 0.912 g/cm³, which are generally prepared with Ziegler-Natta catalysts, chrome catalysts, or single-site catalysts including, but not limited to, bis-metallocene catalysts and constrained geometry catalysts.

“Propylene-based interpolymer” means a polymer having a majority amount (>50 mol %) of units derived from propylene monomer. The term “propylene-based interpolymer” includes homopolymers of propylene such as isotactic polypropylene (polymer repeat units having at least 70 percent isotactic pentads), random copolymers of propylene and one or more C_{2, 4-8} α-olefins in which propylene comprises at least 50 mole percent, and impact copolymers of polypropylene (homopolymer polypropylene and at least one elastomeric impact modifier).

“Blend”, “polymer blend” and like terms mean a composition of two or more polymers. Such a blend may or may not be miscible. Such a blend may or may not be phase separated. Such a blend may or may not contain one or more domain configurations, as determined from transmission electron spectroscopy, light scattering, x-ray scattering, and any other method known in the art. Blends are not laminates, but one or more layers of a laminate may contain a blend. Such blends can be prepared as dry blends, formed in situ (e.g., in a reactor), melt blends, or using other techniques known to those of skill in the art.

The term “multilayer structure” refers to any structure comprising two or more layers having different compositions and includes, without limitation, multilayer films, multilayer sheets, laminated films, multilayer rigid containers, multilayer pipes, and multilayer coated substrates.

In one aspect, the present invention provides a resin for use as a tie layer in a multilayer structure, the resin comprising a maleic anhydride grafted polyolefin, and an inorganic Brønsted acid catalyst. The inorganic Brønsted acid catalyst, in some embodiments, comprises sodium bisulfate, monosodium phosphate, disodium phosphate, phosphoric acid, or combinations thereof. In some embodiments, the resin further comprises a polyolefin. In some embodiments further comprising a polyolefin, the polyolefin is polyethylene. In some embodiments, the resin comprises 50 to 10,000 ppm of the inorganic Brønsted acid catalyst. The resin comprises 50 to 2,000 ppm of the inorganic Brønsted acid catalyst in some embodiments. In some embodiments, the resin comprises 500 to 1,500 ppm of the inorganic Brønsted acid catalyst. In some embodiments, the maleic anhydride grafted polyolefin is maleic anhydride grafted polyethylene having a density of 0.865 to 0.970 g/cm³ and a grafted maleic anhydride level of 0.01 and 2.4 wt % maleic anhydride based on the weight of the maleic anhydride grafted polyethylene.

In some embodiments, a resin for use as a tie layer in a multilayer structure comprises 1 to 90 weight percent of a maleic anhydride grafted polyolefin, 10 to 99 weight percent of a polyolefin, and an inorganic Brønsted acid catalyst, with the weight amounts being based on the total weight of the resin. In some such embodiments, the inorganic Brønsted acid catalyst comprises sodium bisulfate, monosodium phosphate, disodium phosphate, phosphoric acid, or combinations thereof. In some such embodiments, the polyolefin is polyethylene.

In some embodiments, a resin for use as a tie layer in a multilayer structure comprises 1 to 90 weight percent of a maleic anhydride grafted polyolefin, 10 to 99 weight percent of a polyolefin, and 50 to 10,000 ppm of an inorganic Brønsted acid catalyst, with the weight amounts being based on the total weight of the resin. In some such embodiments, the inorganic Brønsted acid catalyst comprises sodium bisulfate, monosodium phosphate, disodium phosphate, phosphoric acid, or combinations thereof. In some such embodiments, the polyolefin is polyethylene.

In some embodiments, a resin for use as a tie layer in a multilayer structure comprises 1 to 10 weight percent of a maleic anhydride grafted polyolefin, 90 to 99 weight percent of a polyolefin, and an inorganic Brønsted acid catalyst, with the weight amounts being based on the total weight of the resin. In some such embodiments, the inorganic Brønsted acid catalyst comprises sodium bisulfate, monosodium phosphate, disodium phosphate, phosphoric acid, or combinations thereof. In some such embodiments, the polyolefin is polyethylene.

In some embodiments, a resin for use as a tie layer in a multilayer structure comprises 1 to 10 weight percent of a maleic anhydride grafted polyolefin, 90 to 99 weight percent of a polyolefin, and 50 to 10,000 ppm of an inorganic Brønsted acid catalyst, with the weight amounts being based on the total weight of the resin. In some such embodiments, the inorganic Brønsted acid catalyst comprises sodium bisulfate, monosodium phosphate, disodium phosphate, phosphoric acid, or combinations thereof. In some such embodiments, the polyolefin is polyethylene.

In some embodiments, a resin for use as a tie layer in a multilayer structure comprises 1 to 10 weight percent of a maleic anhydride grafted polyolefin, 90 to 99 weight percent polyethylene, and 50 to 10,000 ppm of an inorganic Brønsted acid catalyst comprising sodium bisulfate, monosodium phosphate, disodium phosphate, phosphoric acid, or combinations thereof, with the weight amounts being based on the total weight of the resin. In some embodiments, a resin for use as a tie layer in a multilayer structure comprises stearic acid. In some such embodiments, the resin comprises 100 to 1000 ppm stearic acid based on the total weight of the resin.

The resin can comprise a combination of two or more embodiments as described herein.

Some embodiments of the present invention relate to multilayer structures. In some embodiments, a multilayer structure comprises at least three layers, each layer having opposing facial surfaces and arranged in the order A/B/C, wherein Layer A comprises polyolefin; Layer B comprises a resin for use as a tie layer according to any of the embodiments disclosed herein, and wherein a top facial surface of Layer B is in adhering contact with a bottom facial surface of Layer A; and Layer C comprises ethylene vinyl alcohol, polyamide, polycarbonate, polyethylene terephthalate, polyethylene terephthalate glycol-modified, polyethylene furanoate, cellulose, metal substrate, or combinations thereof, wherein a top facial surface of Layer C is in adhering contact with a bottom facial surface of Layer B.

In some embodiments, a multilayer structure comprises at least three layers, each layer having opposing facial surfaces and arranged in the order A/B/C, wherein Layer A comprises polyolefin; Layer B comprises a blend of a second polyolefin, a maleic anhydride grafted polyolefin, and an inorganic Brønsted acid catalyst, wherein Layer B comprises 50 to 2000 ppm of the catalyst based on the total weight of Layer B, and wherein a top facial surface of Layer B is in adhering contact with a bottom facial surface of Layer A; and Layer C comprises ethylene vinyl alcohol, polyamide, polycarbonate, polyethylene terephthalate, polyethylene terephthalate glycol-modified, polyethylene furanoate, cellulose, metal substrate, or combinations thereof, wherein a top facial surface of Layer C is in adhering contact with a bottom facial surface of Layer B. In some embodiments, the inorganic Brønsted acid catalyst comprises sodium bisulfate, monosodium phosphate, disodium phosphate, phosphoric acid, or combinations thereof.

Multilayer structures of the present invention comprise a combination of two or more embodiments as described herein.

Embodiments of the present invention also relate to articles comprising any of the multilayer structures (e.g., multilayer films) disclosed herein. Some embodiments of the present invention relate to packages, laminates, and structural panels. A package of the present invention comprises a multilayer structure according to any of the embodiments disclosed herein. A laminate of the present invention comprises a multilayer structure according to any of the embodiments disclosed herein. A structural panel of the present invention comprises a multilayer structure according to any of the embodiments disclosed herein.

### Resin for Tie Layer

Resins for use as tie layers according to some embodiments of the present invention comprise a maleic anhydride grafted polyolefin, and an inorganic Brønsted acid catalyst. The inorganic Brønsted acid catalyst, in some embodiments, comprises sodium bisulfate, monosodium phosphate, disodium phosphate, phosphoric acid, or combinations thereof. As set forth further below, in some embodiments, such resins can further comprise other polyolefins, stearic acid, and other components.

Maleic Anhydride Grafted Polyolefin

The resin comprises a maleic anhydride grafted polyolefin (MAH-g-PO). Examples of such maleic anhydride grafted polyolefins include maleic anhydride grafted polypropylene and maleic anhydride grafted polyethylene. While this discussion will focus on maleic anhydride grafted polyethylene (MAH-g-PE), persons of skill in the art can select other appropriate maleic anhydride grafted polyolefins for use in the inventive resins based on the teachings herein.

The MAH-g-PE may include a polyethylene having a density of from 0.865 g/cm³ to 0.970 g/cm³. In further embodiments, the density may be from 0.865 g/cm³ to 0.940 g/cm³, or from 0.870 g/cm³ to 0.930 g/cm³.

In some embodiments, the MAH-g-PE has a melt index (I₂) of 0.2 g/10 minutes to 700 g/10 minutes. All individual values and subranges between 0.2 and 700 g/10 minutes are included herein and disclosed herein. For example, the MAH-g-PE can have a melt index from a lower limit of 0.2, 1, 2, 3, 4, 5, 6, 7, 8, 9, 10, or 11 g/10 minutes to an upper limit of 5, 6, 7, 8, 9, 10, 11, 12, 13, 14, 15, 25, 45, 50, 75, 100, 125, 180, 200, 300, 400, 450, 500, 550, 600, 625, 675, or 700 g/10 minutes. The MAH-g-PE has a melt index (I₂) of 1 to 15 g/10 minutes in some embodiments. The MAH-g-PE has a melt index (I₂) of 2 to 10 g/10 minutes in some embodiments. In some embodiments, the MAH-g-PE has a melt index (I₂) of 3 to 7 g/10 minutes.

Various polyethylenes are considered suitable for the maleic anhydride grafted polyethylene. The maleic anhydride grafted polyethylene may include ethylene/α-olefin copolymers, wherein the α-olefin comonomer includes C₄-C₂₀ olefins. For example, the functionalized polyethylene may include LLDPE, LDPE, VLDPE, ULDPE, HDPE, ethylene-based polyolefin plastomers, or combinations thereof. In a further embodiment, the functionalized polyethylene comprises LLDPE.

The amount of maleic anhydride constituent grafted onto the polyethylene chain is greater than 0.01 weight percent to 3 weight percent (based on the total weight of the grafted polyethylene), as determined by titration analysis, FTIR analysis, or any other appropriate method. More preferably, this amount is 0.03 to 2.4 weight percent based on the weight of the grafted polyethylene. In some embodiments, the amount of maleic anhydride grafted constituents is 0.5 to 2.0 weight percent based on the weight of the grafted polyethylene. The amount of maleic anhydride grafted constituents is 0.6 to 1.0 weight percent, in some embodiments, based on the weight of the grafted polyethylene.

The graft process for MAH-g-PE can be initiated by decomposing initiators to form free radicals, including azo-containing compounds, carboxylic peroxyacids and peroxyesters, alkyl hydroperoxides, and dialkyl and diacyl peroxides, among others. Many of these compounds and their properties have been described (Reference: J. Branderup, E. Immergut, E. Grulke, eds. “Polymer Handbook,” 4th ed., Wiley, New York, 1999, Section II, pp. 1-76.). It is preferable for the species that is formed by the decomposition of the initiator to be an oxygen-based free radical. It is more preferable for the initiator to be selected from carboxylic peroxyesters, peroxyketals, dialkyl peroxides, and diacyl peroxides. Some of the more preferable initiators, commonly used to modify the structure of polymers, are listed in U.S. Pat. No. 7,897,689, in the table spanning Col. 48 line 13—Col. 49 line 29, which is hereby incorporated by reference. Alternatively, the grafting process for MAH-g-PE can be initiated by free radicals generated by thermal oxidative process.

Various commercial products are considered suitable for the MAH-g-PE. Examples of MAH-g-PE that can be used in the tie layer resin include those commercially available from The Dow Chemical Company under the trade name AMPLIFY™ such as AMPLIFY™ GR 216, AMPLIFY™ TY 1060H, AMPLIFY™ TY 1053H, AMPLIFY™ TY 1057H, and others.

In some embodiments, the MAH-g-PO (e.g., MAH-g-PE) comprises 1 to 99.995 weight percent of the tie layer resin, based on the weight of tie layer resin. The tie layer resin, in some embodiments, comprises 1 to 99 weight percent of the MAH-g-PO based on the weight of the tie layer resin. In some embodiments, the MAH-g-PO (e.g., MAH-g-PE) comprises 90 to 99.995 weight percent of the tie layer resin, based on the weight of tie layer resin. The tie layer resin, in some embodiments, comprises 90 to 99 weight percent of the MAH-g-PO based on the weight of the tie layer resin. In some embodiments, the MAH-g-PO (e.g., MAH-g-PE) comprises 95 to 99.995 weight percent of the tie layer resin, based on the weight of tie layer resin. The tie layer resin, in some embodiments, comprises 95 to 99 weight percent of the MAH-g-PO based on the weight of the tie layer resin.

As set forth herein, in some embodiments, the tie layer resin can further comprise a non-functionalized polyolefin such as polyethylene. In some such embodiments, the MAH-g-PO comprises 1 to 50 weight percent of the tie layer resin, based on the weight of the tie layer resin. The MAH-g-PO comprises 1 to 15 weight percent of the tie layer resin, based on the weight of the resin, in some embodiments. In some such embodiments, the MAH-g-PO comprises 1 to 10 weight percent of the tie layer resin, based on the weight of the tie layer resin. The MAH-g-PO comprises 5 to 25 weight percent of the tie layer resin, based on the weight of the resin, in some embodiments. In some such embodiments, the MAH-g-PO comprises 10 to 15 weight percent of the tie layer resin, based on the weight of the tie layer resin. It should be understood that in embodiments where the tie layer resin comprises a non-functionalized polyolefin, such as polyethylene, the polyolefin can be part of a pellet (in addition to the MAH-g-PO, the inorganic Brønsted acid catalyst, and other components) that is melted and extruded into the tie layer, or can be blended in-line at an extruder.

Inorganic Brønsted Acid Catalyst

The resins for use as tie layers according to embodiments of the present invention further comprise an inorganic Brønsted acid catalyst. A Brønsted acid is a compound that can transfer a proton to another compound.

The inorganic Brønsted acid catalyst can advantageously be included to promote the adhesion of the tie layer to an adjacent layer formed primarily from a polar polymer (“a polar layer”) or other non-polyolefin (e.g., a metal substrate), while also adhering to a polyolefin layer on the opposite side of the tie layer from the polar layer, in some embodiments. Examples of such polar layers can include barrier layers formed from ethylene vinyl alcohol or polyamide, polyethylene terephthalate layers, and other layers discussed further herein. The inclusion of the inorganic Brønsted acid catalyst is believed to enhance the kinetic rate of covalent bond formation between the polar layer (e.g., barrier layer) and the maleic anhydride functionality of the MAH-g-PO in the tie layer. Thus, with an increase in this kinetic rate, the inorganic Brønsted acid catalyst can be included to promote the adhesion strength.

For example, the resins for use as a tie layer according to some embodiments of the present invention can be used in tie layers to adhere a polar layer (e.g., barrier layer) to another layer comprising a polyolefin such as polyethylene. For example, as barrier layers typically comprise ethylene vinyl alcohol and/or polyamide (as well as others discussed herein), the catalyst, in some embodiments, can be selected so as to promote a reaction between maleic anhydride functional groups in the maleic anhydride grafted polyolefin with hydroxyl groups in the ethylene vinyl alcohol and/or amine groups in the polyamide of a barrier layer. Inorganic Brønsted acid catalyst are believed to be particularly well-suited for such embodiments. The ability of the inorganic Brønsted acids to enhance such covalent bonding in a molten polymer system is particularly unique because the matrix is primarily composed of non-polar components. While Brønsted acids have been used for catalysis in water, alcohol, and other polar solutions, the catalytic benefit provided by the inorganic Brønsted acids in a non-polar molten polymer matrix as provided in the present invention is surprising. Further advantages are realized in the utility of increasing the bonding force between layers in co-extruded multilayer structures.

Thus, in some embodiments, a resin for use as a tie layer comprises an inorganic Brønsted acid catalyst. In some embodiments, the inorganic Brønsted acid catalyst is effective to catalyze acylation of alcohols and amines. Examples of inorganic Brønsted acid catalysts that can be used in embodiments of the present invention include sodium bisulfate, monosodium phosphate, disodium phosphate, phosphoric acid, and combinations thereof.

The amount of inorganic Brønsted acid catalyst used in the resin can depend on a number of factors including the amount of maleic anhydride grafted polyolefin in the resin, the amount of other components (e.g., polyolefin, stearic acid, etc.) in the resin, the catalyst used, the composition of the polar or barrier layer and other layers adjacent to the tie layer formed from the resin, and other factors. In some embodiments, the resin comprises 50 to 10000 parts per million by weight of the inorganic Brønsted acid catalyst based on the total weight of the resin. The resin, in some embodiments, comprises 50 to 2000 parts per million by weight of the inorganic Brønsted acid catalyst based on the total weight of the resin. The resin comprises 200 to 1500 parts per million by weight of the inorganic Brønsted acid catalyst based on the total weight of the resin in some embodiments. The resin, in some embodiments, comprises 200 to 1200 parts per million by weight of the inorganic Brønsted acid catalyst based on the total weight of the resin.

The inorganic Brønsted acid catalyst can be added at a number of different times to provide a resin for use as a tie layer according to embodiments of the present invention. For example, in some embodiments the inorganic Brønsted acid catalyst can be added when a polyolefin is grafted with maleic anhydride to provide the maleic anhydride grafted polyolefin. As additional examples, the inorganic Brønsted acid catalyst can be added when a pellet is formed comprising the MAH-g-PO and any other components of a tie layer resin, or the inorganic Brønsted acid catalyst can be blended in-line at an extruder with the other components of the tie layer resin.

Polyolefin

In some such embodiments, the resin for use as a tie layer can further comprise one or more polyolefins such as polyethylene, polypropylene, or blends thereof.

The tie layer resin, in some embodiments, comprises polyethylene. In such embodiments, the tie layer resin can comprise any polyethylene known to those of skill in the art to be suitable for use as in resins for tie layers based on the teachings herein. Examples of polyethylenes that can be used in such tie layer resins include low density polyethylene (LDPE), linear low density polyethylene (LLDPE), medium density polyethylene (MDPE), ultra-low density polyethylene (ULDPE); very low density polyethylene (VLDPE); single-site catalyzed linear low density polyethylene, including both linear and substantially linear low density resins (m-LLDPE); high density polyethylene (HDPE), polyolefin plastomers, polyolefin elastomers, enhanced polyethylenes, and others.

The tie layer resin, in some embodiments, comprises polypropylene. In such embodiments, the tie layer resin can comprise any polypropylene known to those of skill in the art to be suitable for use as in resins for tie layers based on the teachings herein.

In some embodiments, the polyolefin is a polyethylene having a density of from 0.865 g/cm³ to 0.970 g/cm³. In further embodiments, the density may be from 0.865 g/cm³ to 0.940 g/cm³, or from 0.870 g/cm³ to 0.930 g/cm³.

In some embodiments, the polyolefin is a polyethylene having a melt index (I₂) of 0.2 g/10 minutes to 700 g/10 minutes. All individual values and subranges between 0.2 and 700 g/10 minutes are included herein and disclosed herein. For example, the polyethylene can have a melt index from a lower limit of 0.2, 1, 2, 3, 4, 5, 6, 7, 8, 9, 10, or 11 g/10 minutes to an upper limit of 5, 6, 7, 8, 9, 10, 11, 12, 13, 14, 15, 25, 45, 50, 75, 100, 125, 180, 200, 300, 400, 450, 500, 550, 600, 625, 675, or 700 g/10 minutes. The polyethylene has a melt index (I₂) of 1 to 15 g/10 minutes in some embodiments. The polyethylene has a melt index (I₂) of 2 to 10 g/10 minutes in some embodiments. In some embodiments, the polyethylene has a melt index (I₂) of 3 to 7 g/10 minutes.

In some embodiments, the polyolefin comprises 10 to 99 weight percent of the tie layer resin, based on the weight of the resin. The resin, in some embodiments, comprises 90 to 99 weight percent of the polyolefin based on the weight of the tie layer resin. In some embodiments, the polyethylene comprises 94 to 99 weight percent of the tie layer resin, based on the weight of the resin.

Stearic Acid

In some embodiments, the resin for use as a tie layer can further comprise stearic acid (octadecanoic acid). While not wishing to be bound by any particular theory, it is believed that stearic acid aids in the dispersion of the inorganic Brønsted acid catalyst in the polymer matrix and thus may further help catalyze the reaction between the maleic anhydride functionality of the MAH-g-PO in the tie layer and functional groups on a polymer used to form the adjacent layer.

Stearic acid is a saturated fatty acid having a chain of carbon atoms. Stearic acid that can be used in some embodiments of the present invention is commercially available from a variety of sources. Persons of skill in the art can identify other fatty acids that can be used instead of stearic acid based on the teachings herein including, for example, oleic acid (CH₃(CH₂)₇CH═CH(CH₂)₇COOH), palmitic acid (CH₃(CH₂)₁₄COOH), and the like. Such fatty acids can be used in some embodiments of the present invention in amounts similar to those described below for stearic acid.

The amount of stearic acid to be used in the tie layer resin can depend on a number of factors including the amount of maleic anhydride grafted polyolefin in the resin, the amount of inorganic Brønsted acid catalyst in the resin, the amount of other components (e.g., polyolefin, etc.) in the resin, the type of inorganic Brønsted acid catalyst used, the composition of the polar or barrier layer and other layers adjacent to the tie layer formed from the resin, and other factors. In some embodiments, the resin comprises 50 to 5000 parts per million by weight stearic acid based on the total weight of the resin. In some embodiments, the resin comprises 100 to 2000 parts per million by weight stearic acid based on the total weight of the resin. The resin, in some embodiments, comprises 200 to 1000 parts per million by weight stearic acid based on the total weight of the resin.

When formed into a tie layer, resins of the present invention can provide a number of advantages. For example, by improving the reaction rate between the maleic anhydride functionality of the MAH-g-PO in the tie layer with the functional groups of a polymer used to form a barrier layer (e.g., the hydroxyl groups in ethylene vinyl alcohol or the amine groups in polyamide), the resin can provide increased adhesion. In some embodiments, when incorporated in a tie layer, resins of the present invention can provide the same or similar adhesion at lower temperatures during formation of multilayer structures which is advantageous to some manufacturers when a low temperature process is desired. In some embodiments, when incorporated in a tie layer, resins of the present invention can provide the same or similar level of adhesion at faster line speeds during formation of multilayer structures which is advantageous. In a further embodiment, when incorporated in a tie layer, resins of the present invention can provide improved adhesion at the same process temperatures and same process line speed during formation of multilayer structures, which is advantageous.

### Adjacent Polar or Barrier Layer (Layer C)

In embodiments of the present invention related to multilayer structures, a tie layer formed from a resin of the present invention can be in adhering contact with an adjacent polar layer or barrier layer. The polar or barrier layer may comprise one or more polyamides (nylons), amorphous polyamides (nylons), ethylene vinyl alcohol copolymers (EVOH), polyethylene terephthalates (PET), polyethylene terephthalate glycol-modified (PETG), polyethylene furanoates, polycarbonates, cellulose, metal substrates, or combinations thereof, and can include scavenger materials and compounds of heavy metals like cobalt with MXD6 nylon. EVOH includes a vinyl alcohol copolymer having 27 to 44 mol % ethylene, and is prepared by, for example, hydrolysis of vinyl acetate copolymers. Examples of commercially available EVOH that can be used in embodiments of the present invention include EVAL™ from Kuraray and Noltex™ and Soamol™ from Nippon Goshei.

In some embodiments, when the adjacent layer is a barrier layer, the barrier layer can comprise EVOH and an anhydride and/or carboxylic acid functionalized ethylene/alpha-olefin interpolymer, such as those barrier layers disclosed in PCT Publication No. WO 2014/113623, which is hereby incorporated by reference. This inclusion of anhydride and/or carboxylic acid functionalized ethylene/alpha-olefin interpolymer can enhance the flex crack resistance of the EVOH, and is believed to provide less points of stress at the interlayer with the tie resin, hence decreasing formation of voids that could negatively impact the gas barrier properties of the overall multilayer structure.

In embodiments where the adjacent layer is a barrier layer comprising polyamide, the polyamide can include polyamide 6, polyamide 9, polyamide 10, polyamide 11, polyamide 12, polyamide 6,6, polyamide 6/66 and aromatic polyamide such as polyamide 61, polyamide 6T, MXD6, or combinations thereof.

In embodiments where it is desired to provide a high modulus layer, for example, the adjacent layer can comprise polycarbonate or polyethylene terephthalate, or combinations thereof.

In embodiments where the adjacent layer is a barrier layer comprising a metal substrate, the metal substrate can be a metal foil, such as aluminum foil, or metallized or plasma coated films.

In some embodiments, tie layers formed from a resin of the present invention can be in adhering contact with a top facial surface and/or a bottom facial surface of such layers.

### Other Layers

In some embodiments, a tie layer formed from a resin of the present invention can be in adhering contact with another layer, in addition to a barrier layer. For example, in some embodiments, the tie layer can additionally be in adhering contact with a layer comprising a polyolefin, such as polyethylene (i.e., the tie layer is between the polyethylene layer and the barrier layer). In such an embodiment, the polyethylene can be any polyethylene and its derivatives (e.g., ethylene-propylene copolymer) known to those of skill in the art to be suitable for use as a layer in a multilayer structure based on the teachings herein. The polyethylene can be used in such a layer, as well as other layers in the multilayer structure, in some embodiments, can be ultralow density polyethylene (ULDPE), low density polyethylene (LDPE), linear low density polyethylene (LLDPE), medium density polyethylene (MDPE), high density polyethylene (HDPE), high melt strength high density polyethylene (HMS-HDPE), ultrahigh density polyethylene (UHDPE), homogeneously branched ethylene/α-olefin copolymers made with a single site catalyst such as a metallocene catalyst or a constrained geometry catalyst, and combinations thereof.

Some embodiments of multilayer structures can include layers beyond those described above. For example, while not necessarily in adhering contact with a tie layer according to the present invention, a multilayer structure can further comprise other layers typically included in multilayer structures depending on the application including, for example, other barrier layers, sealant layers, other tie layers, other polyethylene layers, polypropylene layers, etc. For example, in some embodiments, a multilayer structure of the present invention can include both an inventive tie layer (e.g., a tie layer formed from a resin of the present invention) and a conventional tie layer. As to conventional tie layers, the conventional tie layer can be any tie layer known to those of skill in the art to be suitable for use in adhering different layers in a multilayer structure based on the teachings herein.

Additionally, other layers such as printed, high modulus, high gloss layers may be laminated to multilayer structures (e.g., films) of the present invention. Further, in some embodiments, the multi-layer structure can be extrusion coated to a fiber containing substrate such as paper.

To those skilled in the art, the addition of an inorganic Brønsted acid catalyst will enhance the bonding of the maleic anhydride to a reactive proton such as in an alcohol (OH functionality), amine (NH functionality), metal hydroxide (metal —OH functionality), and sulfide (SH functionality). These functional groups may be a chemical component in a bonding polymer such as in polyethylene terephthalate (PET), polylactic acid, polyethylene glycol, and others containing the aforementioned functionalities. It is further anticipated that those skilled in the art could induce hydroxide functionality via high energy surface activation such as using corona discharge or flame treatment. Thus, tie layers formed from a resin of the present invention can be used between a variety of other layers in a multilayer structure as will be evident to those of skill in the art based on the teachings herein.

### Additives

It should be understood that any of the foregoing layers can further comprise one or more additives as known to those of skill in the art such as, for example, antioxidants, ultraviolet light stabilizers, thermal stabilizers, slip agents, antiblock, pigments or colorants, processing aids, crosslinking catalysts, flame retardants, fillers and foaming agents.

### Multilayer Structures

Tie layers formed from resins of the present invention can be incorporated in a variety of multilayer structures. Such tie layers are particularly useful in multilayer structures where gas and/or moisture resistance is a desirable feature. As noted above, in some such embodiments, the multilayer structure will include at least one polar or barrier layer (e.g., a layer comprising ethylene vinyl alcohol, polyamide, polycarbonate, polyethylene terephthalate, polyethylene furanoate, metal substrate, or combinations thereof) with a tie layer formed from a resin according to the present invention in adhering contact with either or both surfaces of the barrier layer. In some embodiments, the multilayer structure will include a polar or barrier layer (e.g., a layer comprising ethylene vinyl alcohol, polyamide, polycarbonate, polyethylene terephthalate, polyethylene furanoate, metal substrate, or combinations thereof) in adhering contact with the bottom facial surface of an inventive tie layer formed from a resin according to the present invention, and a layer comprising a polyolefin (e.g., polyethylene) in adhering contact with a top facial surface of the inventive tie layer. A number of examples of such structures are disclosed elsewhere in the present application. Such structures can include a number of other layers as will be apparent to those of skill in the art based on the teachings herein.

As another example, tie layers formed from resins of the present invention can also be used in adhering a polyethylene layer to a polypropylene layer, a polyethylene layer to a polyethylene terephthalate layer, and others.

For example, in one embodiment, a multilayer structure of the present invention can have an A/B/C/B/E structure as follows: polyethylene/inventive tie layer/barrier layer (EVOH or polyamide)/inventive tie layer/polyethylene.

As another example, a multilayer structure of the present invention can have an A/B/C/B/C/B/E structure as follows: polyethylene/inventive tie layer/barrier layer (EVOH or polyamide)/inventive tie layer/barrier layer (EVOH or polyamide)/inventive tie layer/polyethylene.

As another example, a multilayer structure of the present invention can have an A/B/C/D/C/B/E structure as follows: polyethylene/inventive tie layer/barrier layer (polyamide)/barrier layer (EVOH)/barrier layer (polyamide)/inventive tie layer/polyethylene.

As another example, a multilayer structure of the present invention can have an A/B/C/D/E/D/F structure as follows: (biaxially oriented polyethylene terephthalate or biaxially oriented polyamide or biaxially oriented polypropylene)/adhesive layer/polyethylene/inventive tie layer/barrier layer (EVOH or polyamide)/inventive tie layer/polyethylene.

As another example, a multilayer structure of the present invention can have an A/B/C/D structure as follows: polyethylene/inventive tie layer/barrier layer (nylon or EVOH)/cellulose. As another example, a multilayer structure of the present invention can have an A/B/C/D/E structure as follows: polyethylene/inventive tie layer/barrier layer (EVOH or polyamide)/conventional tie layer/polyethylene.

As another example, a multilayer structure of the present invention can have an A/B/C/D/E/F/G structure as follows: (biaxially oriented polyethylene terephthalate or biaxially oriented polyamide or biaxially oriented polypropylene)/adhesive layer/polyethylene/conventional tie layer/barrier layer (EVOH or polyamide)/inventive tie layer/polyethylene.

As another example a multilayer structure of the present invention can have an A/B/C/D/E/D/F structure as follows: polyethylene/inventive tie layer/barrier layer (EVOH)/conventional tie layer/polyethylene/conventional tie layer/polyamide. In a further embodiment, the multilayer structure can further comprise a fiber containing substrate that is extrusion laminated to the structure.

Some of the above exemplary multilayer structures have polyethylene layers that are identified using different layer designations (e.g., in the first example, Layers A and E are each polyethylene layers). It should be understood that in some embodiments, such polyethylene layers can be formed from the same polyethylene, or polyethylene blends, while in other embodiments, such polyethylene layers can be formed from different polyethylenes or polyethylene blends. In some embodiments, such polyethylene layers (e.g., in the first example, Layers A and E) can be the outermost layers or skin layers. In other embodiments, the multilayer structure may comprise one or more additional layers adjacent to such polyethylene layers. It should be understood that for the examples above, the first and last layers identified for each example may be the outermost layer in some embodiments, while in other embodiments, one or more additional layers may be adjacent to such layers.

When a multilayer structure comprising the combinations of layers disclosed herein is a multilayer film, the film can have a variety of thicknesses depending, for example, on the number of layers, the intended use of the film, and other factors. In some embodiments, multilayer films of the present invention have a thickness of 15 microns to 5 millimeters. Multilayer films of the present invention, in some embodiments, have a thickness of 20 to 500 microns (preferably 50-200 microns). When the multilayer structure is something other than a film (e.g., a rigid container, a pipe, etc.), such structures can have a thickness within the ranges typically used for such types of structures.

Multilayer structures of the present invention can exhibit one or more desirable properties. For example, in some embodiments, multilayer structures can exhibit desirable barrier properties, temperature resistance, optical properties, stiffness, sealing, toughness, puncture resistance, and/or others.

### Methods of Preparing Multilayer Structures

When the multilayer structure is a multilayer film or formed from a multilayer film, such multilayer films can be coextruded as blown films or cast films using techniques known to those of skill in the art based on the teachings herein. In particular, based on the compositions of the different film layers disclosed herein, blown film manufacturing lines and cast film manufacturing lines can be configured to coextrude multilayer films of the present invention in a single extrusion step using techniques known to those of skill in the art based on the teachings herein.

Other multilayer structures can be formed by extrusion coating a multilayer film incorporating an inventive resin as the tie layer onto a substrate.

Embodiments of resins for use as tie layers are particularly advantageous in high throughput film lines as the inclusion of the inorganic Brønsted acid catalyst increases the rate of adhesion of the tie layer to adjacent layers and, in some cases, at lower temperatures.

Embodiments of resins for use as tie layers can be particularly advantageous in blown film lines where the film is stretched after the initial forming process as the inclusion of the inorganic Brønsted acid catalyst increases the level of adhesion of the tie layer to adjacent layers and, in some cases, at lower temperatures. Such processes are known to those skilled in the art as a double bubble process. For example, the inventive technology may provide added adhesion during the annealing process to ensure that the final film performance meets the customer expectations in film integrity. Other advanced processing techniques can also be used.

Inventive resins for use as a tie layer can be provided in a number of ways. For example, the resin can be pre-formulated with the target amounts of MAH-g-PO and inorganic Brønsted acid catalyst (and other components) and provided to a film line as a pellet. In other embodiments, a resin comprising MAH-g-PO and inorganic Brønsted acid catalyst can be compounded with a polyolefin (e.g., polyethylene) in-line at an extruder to provide the target amounts of MAH-g-PO and inorganic Brønsted acid catalyst (and other components) of the tie layer resin. In other embodiments, all of the components can be compounded in-line (i.e., added separately) at an extruder to provide the target amounts of MAH-g-PO and inorganic Brønsted acid catalyst (and other components) of the tie layer resin.

### Packages and Other Products

Multilayer films of the present invention can be formed into a variety of packages using techniques known to those of skill in the art. In general, multilayer films of the present invention can be converted into any form of package and deployed under a variety of environmental conditions. Films of the present invention, in some embodiments, can be particularly useful in converted packages that are subject to, or must undergo high moisture conditions, throughout their service life.

Examples of packages that can be formed from multilayer films of the present invention include, without limitation, stand-up pouches, bags, extrusion coated paper boards, and others.

Other products that can be formed include, for example, multilayer sheets, laminated films, multilayer rigid containers, multilayer pipes, multilayer coated substrates, and structural panels. Such articles can be formed using techniques known to those of skill in the art based on the teachings herein.

### Test Methods

Unless otherwise indicated herein, the following analytical methods are used in the describing aspects of the present invention:

Melt Index

Measure melt index (MI), I₂, in accordance to ASTM D-1238 at 190° C. and at 2.16 kg, where values in g/10 min that correspond to grams eluted per 10 minutes. In case of maleic anhydride grafted polymers, measure the melt index values at the time of sample preparation as some drift in melt index is expected because of hydrolysis.

Density

Prepare samples according to ASTM D4703. Make measurements within one hour of sample preparation according to ASTM D792, Method B.

Percent MAH Grafting

Determine percent maleic anhydride (MAH) grafting in the first polyolefin, as defined herein, using the ratio of peak heights of the MAH (FTIR_{MAH}) and the peak heights of the maleic acid (FTIR_{MA}) to the peak heights of the polymer reference (FTIR_{ref}). Measure the peak heights of MAH at wave number 1791 cm⁻¹, the peak heights of maleic acid (MA) at 1721 cm⁻¹ and the peak heights of the polyethylene, which are the polymer reference, at 2019 cm⁻¹. Multiply the ratio of peak heights by the appropriate calibration constants (A and B) and add the products of the ratios and calibration constants together to equal the MAH wt %. When polyethylene is the reference polymer, the MAH wt % is calculated according to the following MAH wt % formula:

$$MAH wt \% = A ( \frac{{FTIR}_{M A H} @ 1 \; 791 {cm}^{- 1}}{{FTIR}_{r e f} @ 2 \; 019 {cm}^{- 1}} ) + B ( \frac{{FTIR}_{M A} @ 1 \; 721 {cm}^{- 1}}{{FTIR}_{r e f} @ 2 \; 019 {cm}^{- 1}} )$$

Determine the calibration constant A using C¹³ NMR standards, which are known in the field. The actual calibration constant may differ slightly depending on the instrument and the polymers. The peak heights of maleic acid account for the presence of maleic acid in the polyolefins, which is negligible for freshly grafted polyolefins. However, over time, and in the presence of moisture, maleic anhydride is converted to maleic acid. For MAH grafted polyolefins having a high surface area, significant hydrolysis can occur under ambient conditions in just a few days. The calibration constant B is a correction for the difference in extinction coefficients between the anhydride and acid groups, which can be determined by standards known in the field. The MAH wt. % formula takes different sample thicknesses into account to normalize the data.

Prepare a sample of the MAH grafted polyolefin for FTIR analyst in a heating press. Place a 0.05 mm to about 0.15 mm in thickness sample of the MAH grafted polyolefin between suitable protective films, such as MYLAR™ or TEFLON™, to protect it from the platens of the heating press. Place the sample in the heating press at a temperature of about 150-180° C. press under about 10 tons of pressure for about five minutes. Allow the sample to remain in the heating press for about one hour and then allow to cool to room temperature (23° C.) before scanning in the FTIR.

Run a background scan on the FTIR before scanning each sample, or as needed. Place the sample in an appropriate FTIR sample holder and scan in the FTIR. The FTIR will typically display an electronic graph providing the peak heights of MAH at wave number 1791 cm⁻¹, the peak heights of maleic acid at 1721 cm⁻¹, and the peak heights of polyethylene at 2019 cm⁻¹. The FTIR test should have an inherent variability less than +/−5%.

Additional properties and test methods are described further herein.

Some embodiments of the invention will now be described in detail in the following Examples.

### EXAMPLES

The materials listed in Table 1 are used in the Examples:

TABLE 1

| Material | Description | Short Name |
|---|---|---|
| AMPLIFY ® GR 216 | maleic anhydride grafted polyethylene | MAH-g-PE 1 |
| (The Dow Chemical Company) | (density = 0.870 g/cm³; I₂ = 1.25 g/10 | |
| | minutes; maleic anhydride (MAH) graft | |
| | level of greater than 0.5 and less than | |
| | 2.5 weight %) | |
| AMPLIFY ® TY1057H | maleic anhydride grafted polyethylene | MAH-g-PE 2 |
| (The Dow Chemical Company) | (density = 0.912 g/cm³; I₂ = 3.0 g/10 | |
| | minutes; maleic anhydride (MAH) graft | |
| | level of greater than 0.5 and less than | |
| | 2.5 weight %) | |
| sodium bisulfate (NaHSO₄), | | Catalyst 1 |
| anhydrous | | |
| (Sigma-Aldrich) | | |
| trisodium phosphate (Na₃PO₄), | | Catalyst 2 |
| anhydrous | | |
| (Sigma-Aldrich) | | |
| phosphoric acid (H₃PO₄), | | Catalyst 3 |
| anhydrous | | |
| (Sigma-Aldrich) | | |
| Stearic Acid | | Additive 1 |
| (Sigma-Aldrich) | | |
| ENGAGE ® 8200 | polyolefin elastomer (ethylene-octene | Polyolefin 1 |
| (The Dow Chemical Company) | copolymer; density = 0.870 g/cm³; I₂ = | |
| | 5.0 g/10 minutes) | |
| DOW ™ LDPE 722 | LDPE (density = 0.918 g/cm³; I₂ = | Polyolefin 2 |
| | 8.0 g/10 minutes) | |
| DOWLEX ® 2045 | LLDPE (density = 0.920 g/cm³; I₂ = | Polyolefin 3 |
| (The Dow Chemical Company) | 1.0 g/10 minutes) | |
| EVAL E171B | ethylene vinyl alcohol copolymer (44 | EVOH 1 |
| (Kuraray America, Inc.) | mol % ethylene; density = 1.14 g/cm³ | |
| | per ISO1183-3; MFR = 1.7 g/10 | |
| | minutes per ISO1133 (190° C.)) | |
| EVAL H171B | ethylene vinyl alcohol copolymer (38 | EVOH 2 |
| (Kuraray America, Inc.) | mol % ethylene; density = 1.17 g/cm³ | |
| | per ISO1183-3; MFR = 1.7 g/10 | |
| | minutes per ISO1133 (190° C.)) | |
| Ultramid C33L 01 | copolyamide made from polyamide 6 | Polyamide |
| (BASF) | and polymamide 66 (density = 1.12 | |
| | g/cm³ per ISO 1183) | |
| Hydrobrite 550 PO) | white mineral oil | Mineral Oil |
| (Sonneborn LLC) | | |
| kraft paper substrate | | Paper Substrate |

For ease of reference, the Short Name will be used to refer to the corresponding Material in the Examples that follow. Catalysts 1 and 3 are inorganic Brønsted acid catalysts.

### Example 1

In this Example, different catalysts are evaluated for their ability to facilitate the reaction between a maleic anhydride grafted polyethylene (MAH-g-PE 1) and ethylene vinyl alcohol (EVOH 1). Sample 1 utilized Catalyst 1.

10.94 grams of EVOH 1 is added to a 60 cc Haake mixing bowl (Haake PolyLab QC) and melted at 170° C. at 100 rpm under a nitrogen blanket for 5 minutes to make sure that EVOH 1 is in a fully molten state. After 5 minutes, a mixture of 33.41 grams of MAH-g-PE 1 and 0.052 grams of Catalyst 1 are added into the Haake bowl via a funnel with full incorporation of the additional components taking up to one minute. These amounts of EVOH 1 and MAH-g-PE 1 correspond to a 20%/80% by volume blend of EVOH 1 to MAH-g-PE 1, respectively. This ratio is chosen in order for the reaction to not be limited by reactive groups on the MAH-g-PE 1 and so that all of the ethylene vinyl alcohol would have a chance to react to form the blended compound. The components are allowed to mix for an additional 10 minutes before being collected.

Sample 2 is prepared in the same way as Sample 1 except that 0.104 grams of Additive 1 (stearic acid) is included in addition to Catalyst 1. In addition, Comparative Sample 1 is prepared using 100% EVOH 1. Comparative Sample 2 is prepared in the same way as Sample 1 except no catalyst is used. Comparative Sample 3 is prepared in the same way as Sample 1 except that Polyolefin 1 is used instead of MAH-g-PE 1. Polyolefin 1 is a polyethylene with no grafted maleic anhydride. Comparative Sample 4 is prepared in the same way as Sample 1 except that Catalyst 2 is used instead of Catalyst 1.

The inorganic salts used as catalysts in these examples are evaluated for their ability to improve the ester covalent bond formation of maleic anhydride with hydroxyl groups. These catalysts have varied mass weight, melting points, metal ions, and acid/base properties. Particularly, when the catalysts salts are dissolved into water at a concentration of 0.1 M (moles/liter), Catalyst 1 has pH of 1.39, and Catalyst 3 has a pH of 1.6, in the acidic range. In contrast, Catalyst 2 has a pH of 12.23, in the basic range. Catalyst 1 and Catalyst 3 are thus considered inorganic Brønsted acid catalysts, whereas Catalyst 2 is not.

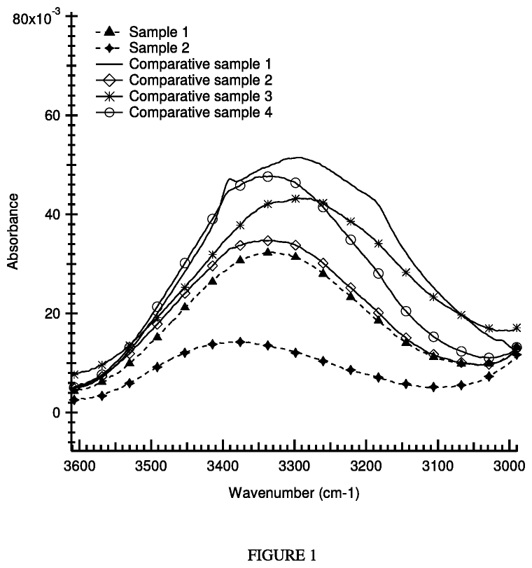

Consumption of the hydroxyl (OH) groups from the ethylene vinyl alcohol after reaction has taken place is monitored by attenuated Fourier-transform infrared spectroscopy (ATR-FTIR). Samples are measured on a Nicolet 8700 FTIR equipped with an ATR attachment with a diamond crystal. Melt blended compounds are taken from the Haake mixer and compression molded to form 1 inch discs suitable for characterization. A Phi compression molder is used to make the discs. 0.8 grams of the melt blended compound was placed into a metal chase and molded at 200° C. with a 2 minute ramp up to 1500 pounds of pressure, held for 6 minutes, and then undergoes a 14 minute cooling cycle where pressure is maintained. Compression molded discs are analyzed by ATR-FTIR with 4 cm−1 resolution and compared against an ambient air background. A peak at ˜3330 cm−1 corresponds to OH stretching coming from the OH groups on the ethylene vinyl alcohol polymer chains. As the reaction takes place, OH will be consumed as it reacts with the maleic anhydride groups grafted on the polyethylene. This stretching mode can be monitored for intensity to show differences in the extent of reaction with and without catalyst. The results are shown in FIG. 1.

The OH region (˜3300 cm−1) of the IR spectra in FIG. 1 shows more depletion of OH groups for Sample 1 compared to not adding a catalyst (Comparative Sample 2). When Additive 1 (stearic acid) is included, the effect is compounded even more as shown for Sample 2. Comparative Sample 4 did not aid the reaction and actually appears to hinder the reaction presumably due to Catalyst 3 having a basic pH. Regarding Comparative Sample 3, no reaction would be expected because there are no maleic anhydride functional groups to cross-link the polyethylene and ethylene vinyl alcohol together.

Sample 3 utilized Catalyst 1. 43.80 grams of EVOH 1 is added to a 60 cc Haake mixing bowl (Haake PolyLab QC) and melted at 170° C. at 100 rpm under a nitrogen blanket for 5 minutes to make sure that EVOH 1 is in a fully molten state. After 5 minutes, a mixture of 8.4 grams of MAH-g-PE 1 and 0.052 grams of Catalyst 1 are added into the Haake bowl via a funnel with full incorporation of the additional components taking up to one minute. These amounts of EVOH 1 and MAH-g-PE 1 correspond to an 84%/16% by weight blend of EVOH 1 to MAH-g-PE 1, respectively. This ratio is chosen in order for the reaction to not be limited by reactive groups on the MAH-g-PE 1 and so that all of the maleic anhydride would have a chance to react with EVOH to form PE-graft-EVOH. The components are allowed to mix for an additional 10 minutes before being cooled down and collected.

Comparative Sample 5 is prepared in the same way as Sample 3 except no catalyst is used. Comparative Sample 6 is prepared in the same way as Sample 3 except that Polyolefin 1 is used instead of MAH-g-PE 1. Polyolefin 1 is a polyethylene with no grafted maleic anhydride.

Apparent molecular weight distributions (MWD) and concentrations of EVOH in some of the Samples and Comparative Samples are determined by size-exclusion chromatograph (SEC). The SEC system is based on a Waters Alliance 2690 operated at 1 mL/minute. The eluent is HPLC grade N, N′-dimethylformamide (DMF) containing lithium nitrate (LiNO₃) at a concentration of 4 grams LiNO₃ per liter of DMF (4 g/L). The eluent is continuously degassed with the online vacuum degasser within the Waters Alliance 2690. The Waters Alliance 2690 is programmed to inject 50 microliters of sample solution. The sample solution is prepared at a concentration of 2 milligrams per milliliter in SEC eluent, and is dissolved by shaking at 80° C. for 4 hours. The sample solution is then held at ambient temperature. All sample solutions are filtered through a 0.45 micron nylon filter prior to injection. SEC separations are performed on a series of two 7.5 millimeter internal diameter×300 millimeter length PLgel Mixed-B columns from Agilent Technologies. A RI 201 differential refractive index detector from Shodex is used for detection. The columns and detector are operated at 50° C. SEC chromatograms are collected and reduced via Cirrus SEC software version 3.3 from Agilent Technologies. 10 narrow polyethylene oxide (PEO) molecular weight standards (Agilent Technologies) covering the molecular weight range from 977 to 3.87 kg/mol are used to set up a conventional molecular weight calibration. The standards are prepared as cocktails at concentrations of 0.5 milligram per milliliter each in SEC eluent. The calibration curve is least squares fit to a first order polynomial. Molecular weight distributions are calculated from the DRI detector chromatogram and the PEO calibration curve under the assumption of constant refractive index increment across the SEC chromatogram. All references to molecular weight are not absolute, but linear PEO equivalent values. The concentration of EVOH is determined by a single point external standard calibration. The results are shown in Table 2:

TABLE 2

| | | | | | | Expected | Detected |
|---|---|---|---|---|---|---|---|
| | | | | | Mw/ | EVOH | EVOH |
| | Composition (weight %) | Mn | Mw | Mz | Mn | wt. % | wt. % |
| Comparative | EVOH 1, control (100%) | 16,150 | 40,140 | 74,240 | 2.49 | 100% | 100% |
| Sample 1 | | | | | | | |
| Comparative | EVOH 1/MAH-g-PE l | 15,660 | 40,290 | 75,240 | 2.57 | 83.9% | 79.8% |
| Sample 5 | (84%/16%) | | | | | | |
| Sample 3 | EVOH 1/MAH-g-PE l | 17,350 | 82,670 | 292,600 | 4.76 | 83.9% | 73.1% |
| | (84%/16%) with | | | | | | |
| | 1000 ppm Catalyst 1 | | | | | | |
| Comparative | EVOH 1/Polyolefin 1 | 16,800 | 51,000 | 114,000 | 3.04 | 83.9% | 82.6% |
| Sample 6 | (84%/16%) with | | | | | | |
| | 1000 ppm Catalyst 1 | | | | | | |

SEC can also detect extent of reaction by screening for unreacted ethylene vinyl alcohol. The cross-linked blend is insoluble, but if there is unreacted or reacted but not-crosslinked ethylene vinyl alcohol, it can be selectively dissolved in DMF. The solution is filtered to remove any insoluble components (the crosslinked portion), and the soluble ethylene vinyl alcohol can be measured by SEC. In all of the samples, ethylene vinyl alcohol is the continuous phase, so there are not discrete domains of ethylene vinyl alcohol trapped in a polyolefin matrix. Thus, any soluble ethylene vinyl alcohol can be dissolved and therefore detected. When catalysts are used (e.g., Sample 3), the molecular weight increases and the polydispersity (Mw/Mn) broadens indicating that there is some cross-reaction of EVOH with maleic anhydride grafted polyethylene occurring. The apparent molecular weight of EVOH becomes large due to cross-reaction of EVOH with maleic anhydride grafted polyolefin. Additionally, if no reaction occurred between EVOH and polyolefin, it is expected that all the added 83.9 wt. % of EVOH would be detected. Therefore, the low EVOH amount detected by SEC suggests an EVOH-polyolefin crosslinked reaction at given reaction conditions. As shown in Table 2, Sample 3 has the lowest EVOH detected (73.1 wt. %), compared with the Comparative Sample 5 (79.8 wt. %) without the Catalyst 1 and Comparative Sample 6 (82.6 wt. %) with non-reactive polyolefin (Polyolefin 1). Results of molecular weight and EVOH detected amounts indicate that Catalyst 1 significantly increases the EVOH-polyolefin crosslinked reaction with less soluble EVOH. Such better covalent reaction is believed to increase interfacial bonding between an EVOH layer and a polyolefin layer in a film structure.

### Example 2

A blown film trial is also conducted so that adhesion between the different layers of a multilayer film can be evaluated. Five layer films are made with the following structure: polyethylene/tie layer/ethylene vinyl alcohol/tie layer/polyethylene. The weak point is most typically the interface between the tie layer and the ethylene vinyl alcohol layer, so the adhesion of films made with and without catalyst is compared. The total maleic anhydride content in the films is relatively low so that any enhancement in adhesion can be detected.

The resins for use in tie layers are first prepared. The maleic anhydride grafted polyethylene used to form the tie layer resins is MAH-g-PE 2. The tie layer resins prepared are shown in Table 3:

TABLE 3

| | |
|---|---|
| Inventive Tie Resin 1 | 500 ppm Catalyst 1 |
| | 4 weight percent MAH-g-PE 2 |
| | Balance Polyolefin 2 |
| Comparative Tie Resin A | 4 weight percent MAH-g-PE 2 |
| | Balance Polyolefin 2 |
| Comparative Tie Resin B | 250 ppm Catalyst 1 |
| | 4 weight percent MAH-g-PE 2 |
| | Balance Polyolefin 2 |

MAH-g-PE 2 is first compounded with the Catalyst 1 (or no catalyst) to produce a master batch. The compounded polymer pellets are dried for 16 hours at 130° F. This master batch is then diluted with more grafted polyolefin and/or unfunctionalized polyolefin until the target MAH-G-PE 2 and Catalyst load level is achieved. These resins are then used to form the Tie Layers as described below. The polyethylene used to form the PE Layers is Polyolefin 2. The ethylene vinyl alcohol used to form the EVOH Layer is EVOH 2.

The blown films are prepared as follows. A four mil (100 microns) thick, five-layer film is blown using a 3 inch diameter die that has a blow-up ratio of 2.5. The structure of the film is as follows: PE Layer/Tie Layer/EVOH Layer/Tie Layer/PE Layer with a layer distribution of 30%/10%/20%/10%/30%. Each component of the film is fed into the blown film die at ˜440° F. with a combined feed rate of 30 pounds per hour. The film is running at ˜14 feet/minute. For samples where a blend is used, a target blend of approximately 10 pounds is produced. The pellets are mixed by hand and then loaded into the corresponding extruder feed hoppers. Approximately 30 minutes of time is allowed for grade transition. Film samples are collected on a 3 inch core roll. Test strips are removed from the roll and labeled as to the run condition.

The adhesion of the Tie Layer to the EVOH Layer is measured as follows. Film samples are cut into 1 inch by 6 inch strips using a die cutter of this dimension. The strips is separated at the Tie Layer/EVOH Layer interface using masking tape at the end of a strip. A T-peel test is then performed on the separated strips using an Instron Universal Testing Machine. A piece of masking tape is placed on the PE Layer side of the films to prevent stretching of the PE Layer. This allows for testing of adhesion between the Tie Layer and the EVOH Layer rather than the strength of the film itself. T-peel tests are performed with a 5 kilogram load cell and the jaw separation rate used is 20 inches/minute. The results are shown in Table 4:

TABLE 4

| | | Average Peel | |
|---|---|---|---|
| | | Strength | |
| | | (Std. Dev.) | |
| Sample | Tie Layer | (N/25 mm) | |
| Inventive Example 1 | Inventive | 0.931 | (0.031) |
| | Tie Resin 1 | | |
| Comparative Example A | Comparative | 0.661 | (0.030) |
| | Tie Resin A | | |
| Comparative Example B | Comparative | 0.591 | (0.045) |
| | Tie Resin B | | |

Films made with Catalyst 1 (sodium bisulfate) in the tie layers (Inventive Example 1) show an improvement in adhesion over films made with no catalyst in the tie layers (Comparative Sample A), indicating that more covalent bond formation occurs when catalyst is present. While Comparative Example B also used Catalyst 1, the loading of 250 ppm did not provide the same increase in adhesion, indicating that a minimum amount of loading may be required depending on the catalyst used.

### Example 3

In this Example, laminates are prepared using an extrusion coating line.

First, tie layer resins are prepared for use in the laminates using Catalyst 1 and Catalyst 3. The maleic anhydride grafted polyethylene used to form the tie layer resins is MAH-g-PE 2. Three master batches (MB) are prepared according to Table 5:

TABLE 5

| Master Batch | Composition |
|---|---|
| MB1 | 96 weight percent (wt %) Polyolefin 3 |
| | 4 wt % MAH-g-PE 2 |
| MB2 | 96 weight percent (wt %) Polyolefin 3 |
| | 4 wt % MAH-g-PE 2 |
| | 1000 ppm Catalyst 1 |
| MB3 | 96 weight percent (wt %) Polyolefin 3 |
| | 4 wt % MAH-g-PE 2B |
| | 1000 ppm Catalyst 3 |

The specified amounts of MAH-g-PE 2 and the specified Catalyst (or no catalyst in the case of MB-1) are tackified with 50-280 ppm of Mineral Oil, and then shaken. The MAH-g-PE 2/Catalyst (where applicable)/Mineral Oil mixture and Polyolefin 3 are then compounded on a Century ZSK-40 twin screw extruder with a 37.125 L/D nine barrel to produce the master batch. These resins are then used to form the Tie Layers as described below.

Laminate samples are produced using an extrusion coating line according to the following general structure: Paper Substrate/Polyamide (10 grams/m²)/Tie Layer (10 grams/m²)/Polyolefin 3 (25 grams/m²). The melt temperature is 600° F., and the line speed is 250-900 feet/minute, as specified in Table 6. Unless otherwise noted, the total coat weight on the Paper Substrate is 45 grams/m².

A variety of laminate samples are produced using various catalyst concentrations, line speeds, and coat weights as shown in Table 6. The Tie Layers are prepared by either using one of the master batches from Table 5 or diluting a master batch to the target catalyst concentration using MB1. Each of the resins used to form the Tie Layers in Laminates 1-12 represent some embodiments of resins of the present invention.

TABLE 6

| | Tie | | Catalyst | Line | Coat |
|---|---|---|---|---|---|
| | Layer | | (Concen- | Speed | Weight |
| Laminate | Composition | | tration) | (ft/min) | (gsm) |
| Comparative | 100% | MB1 | None | 250 | 45 |
| Laminate A | | | | | |
| Laminate 1 | 100% | MB2 | Catalyst 1 | 250 | 45 |
| | | | (1000 ppm) | | |
| Laminate 2 | 50% | MB1 | Catalyst 1 | 250 | 45 |
| | 50% | MB2 | (500 ppm) | | |
| Laminate 3 | 75% | MB1 | Catalyst 1 | 250 | 45 |
| | 25% | MB2 | (250 ppm) | | |
| Laminate 4 | 100% | MB3 | Catalyst 3 | 250 | 45 |
| | | | (1000 ppm) | | |
| Laminate 5 | 50% | MB1 | Catalyst 3 | 250 | 45 |
| | 50% | MB3 | (500 ppm) | | |
| Laminate 6 | 75% | MB1 | Catalyst 3 | 250 | 45 |
| | 25% | MB3 | (250 ppm) | | |
| Laminate 7 | 100% | MB2 | Catalyst 1 | 250 | 28 |
| | | | (1000 ppm) | | |
| Laminate 8 | 100% | MB2 | Catalyst 1 | 500 | 28 |
| | | | (1000 ppm) | | |
| Laminate 9 | 100% | MB2 | Catalyst 1 | 750 | 28 |
| | | | (1000 ppm) | | |
| Laminate 10 | 100% | MB2 | Catalyst 1 | 900 | 28 |
| | | | (1000 ppm) | | |
| Laminate 11 | 75% | MB1 | Catalyst 3 | 450 | 28 |
| | 25% | MB3 | (250 ppm) | | |
| Laminate 12 | 75% | MB1 | Catalyst 3 | 750 | 28 |
| | 25% | MB3 | (250 ppm) | | |

Interlayer adhesion is measured using an Instron test frame running a standard peel-test method. Laminate samples are cut into one inch by six inch strips, and two strips are heat-sealed together ˜0.5 inches from the tops of the strips. The strips are hand peeled at the seal to initiate delamination between the tie layer and the polyamide layer. The top 1″ of each layer of the delaminated sample is stabilized with masking tape and mounted in the Instron clamps. The instrument measured the force required to peel the sample layers at a constant rate of 10 inches/minute and reported the average force needed to perform the delamination. The reported peel force values for each sample represent an average of five specimens tested. In the event that all attempts to initiate interlayer delamination resulted in cohesive failure of the paper substrate, the peel force is reported as ≥8 N. The results are shown in Table 7.

TABLE 7

| | | Line | Coat | Average | |
|---|---|---|---|---|---|
| | Catalyst | Speed | Weight | Peel Force | |
| Laminate | (Concentration) | (ft/min) | (gsm) | (Std. Dev.) | |
| Comparative | None | 250 | 45 | 1.3 N | (0.3) |
| Laminate A | | | | | |
| Laminate 1 | Catalyst 1 | 250 | 45 | ≥8 N | |
| | (1000 ppm) | | | | |
| Laminate 2 | Catalyst 1 | 250 | 45 | 3.4 N | (0.5) |
| | (500 ppm) | | | | |
| Laminate 3 | Catalyst 1 | 250 | 45 | 2.0 N | (0.3) |
| | (250 ppm) | | | | |
| Laminate 4 | Catalyst 3 | 250 | 45 | ≥8 N | (0) |
| | (1000 ppm) | | | | |
| Laminate 5 | Catalyst 3 | 250 | 45 | ≥8 N | (0) |
| | (500 ppm) | | | | |
| Laminate 6 | Catalyst 3 | 250 | 45 | ≥8 N | (0) |
| | (250 ppm) | | | | |
| Laminate 7 | Catalyst 1 | 250 | 28 | ≥8 N | (0) |
| | (1000 ppm) | | | | |
| Laminate 8 | Catalyst 1 | 500 | 28 | 2.2 N | (0.9) |
| | (1000 ppm) | | | | |
| Laminate 9 | Catalyst 1 | 750 | 28 | 1.4 N | (0.1) |
| | (1000 ppm) | | | | |
| Laminate 10 | Catalyst 1 | 900 | 28 | 1.7 N | (0.5) |
| | (1000 ppm) | | | | |
| Laminate 11 | Catalyst 3 | 450 | 28 | 3.0 N | (0.9) |
| | (250 ppm) | | | | |
| Laminate 12 | Catalyst 3 | 750 | 28 | 2.0 | (0.9) |
| | (250 ppm) | | | | |

Relative to the Comparative Laminate A, in which the tie layer contained no catalyst, Laminates 1-3, which contained 250-1000 ppm of Catalyst 1 (NaHSO₄) in the tie layer, showed a significantly stronger adhesion between the tie layer and polyamide layer. The peel force required to delaminate the laminates increased with increasing concentration of Catalyst 1 (NaHSO₄) from 2.0 N at 250 ppm to 3.4 N at 500 ppm to ≥8 N at 1000 ppm. These examples demonstrate how the use of NaHSO₄, an inorganic Brønsted acid catalyst, in tie layer can improve the adhesion in multilayer structures.

Tie layers formulated with 250-1000 ppm of Catalyst 3 (H₃PO₄) (Laminates 4-6) all showed significantly higher adhesion to polyamide than Comparative Laminate A. The concentration dependence of the effect could not be determined as interlayer delamination was not measurable under the test conditions in any of Laminates 4-6. Thus, using identical coat weights and line speeds, tie layers formulated with just 250 ppm of Catalyst 3 (H₃PO₄) gave similar adhesion performance to samples which contained 1000 ppm of Catalyst 1 (NaHSO₄). These examples demonstrate how the use of H₃PO₄, an inorganic Brønsted acid catalyst, in tie layers can improve the adhesion in multilayer structures.

Laminates 7-10 evaluated the performance at varying extrusion coating speeds when Catalyst 1 is used in the tie layer. The adhesion data in Table 7 for these Laminates show that the tie layers formulated with 1000 ppm of Catalyst 1 performs marginally better at 500 ft/min (Laminate 8) than sample without catalyst at 250 feet per minute (Comparative Laminate A). The adhesion data at higher line speeds (750 or 900 ft/min (Laminates 9 and 10)) is comparable to the adhesion measurement for Comparative Laminate A.

Laminates 11-12 evaluated the performance at varying extrusion coating speeds when Catalyst 3 is used in the tie layer. The adhesion of the laminate produced with this tie layer at 450 ft/min (Laminate 11) showed increased adhesion relative to the control run with no catalyst at 250 ft/min (Comparative Laminate A). Further increasing the line speed to 750 ft/min (Laminate 12) resulted in adhesion marginally higher than the control (Comparative Laminate A) and approximately equivalent to the sample run at 500 ft/min with the tie layer compounded with 1000 ppm of Catalyst 1 (Laminate 8).

1. A resin for use as a tie layer in a multilayer structure, the resin comprising:
a maleic anhydride grafted polyolefin; and
an inorganic Brønsted acid catalyst.

2. The resin of claim 1, wherein the inorganic Brønsted acid catalyst comprises sodium bisulfate, monosodium phosphate, disodium phosphate, phosphoric acid, or combinations thereof.

3. The resin of claim 1, further comprising a polyolefin.

4. The resin of claim 3, wherein the polyolefin is polyethylene.

5. The resin of claim 3, wherein the resin comprises 50 to 10,000 ppm of the catalyst based on the total weight of the resin.

6. The resin of any claim 1, further comprising stearic acid.

7. The resin of claim 6, wherein the resin comprises 100 to 1000 ppm stearic acid based on the total weight of the resin.

8. The resin of claim 1, wherein the maleic anhydride grafted polyolefin is maleic anhydride grafted polyethylene having a density of 0.865 to 0.970 g/cm³ and a grafted maleic anhydride level of 0.01 and 2.4 wt % maleic anhydride based on the weight of the maleic anhydride grafted polyethylene.

9. A multilayer structure comprising at least three layers, each layer having opposing facial surfaces and arranged in the order A/B/C, wherein:
Layer A comprises polyolefin;
Layer B comprises a blend of a second polyolefin, a maleic anhydride grafted polyolefin, and an inorganic Brønsted acid catalyst, wherein Layer B comprises 50 to 2000 ppm of the catalyst based on the total weight of Layer B, and wherein a top facial surface of Layer B is in adhering contact with a bottom facial surface of Layer A; and
Layer C comprises ethylene vinyl alcohol, polyamide, polycarbonate, polyethylene terephthalate, polyethylene terephthalate glycol-modified, polyethylene furanoate, cellulose, metal substrate, or combinations thereof, wherein a top facial surface of Layer C is in adhering contact with a bottom facial surface of Layer B.

10. The multilayer structure of claim 9, wherein the inorganic Brønsted acid catalyst comprises sodium bisulfate, monosodium phosphate, disodium phosphate, phosphoric acid, or combinations thereof.

11. A package comprising the multilayer structure of claim 9.

12. A laminate comprising the multilayer structure of claim 9.

13. A structural panel comprising the multilayer structure of claim 9.
